(19) United States
(12) Patent Application Publication
(10) Pub. No.: US 2001/0034594 A1
(43) Pub. Date: Oct. 25, 2001

(54) Design verification method, design verification device for microprocessors, and pipeline simulator generation device

(75) Inventors: Kazuyoshi Kohno, Kawasaki-shi (JP); Atsushi Mizuno, Yokohama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Kawasaki-shi (JP)

(21) Appl. No.: 09/816,480

(22) Filed: Mar. 26, 2001

(30) Foreign Application Priority Data
Mar. 27, 2000 (JP) 2000-87411

(51) Int. Cl. G06F 17/50

(52) U.S. Cl. 703/14

(57) ABSTRACT

In the design verification method, the design verification device, and the pipeline simulator generation device for microprocessors, a pipeline simulator (4, S4, S12) and verification programs for a microprocessor as a target in design are automatically generated (7, S9, S10) based on a pipeline specification described in a description language readable and analyzable by a computer, and the pipeline operation of the microprocessor is verified (12, S15, S16) based on the results (S13) of the simulation (11) of the RTL description and the result (6, S14) of the pipeline simulation performed based on the verification programs and the pipeline simulator.

### CROSS-REFERENCE TO RELATED APPLICATION

This application claims benefit of priority under 35 USC § 119 to Japanese Patent Application No. 2000-87411, filed on Mar. 27, 2000, the entire contents of which are incorporated by reference herein.

### BACKGROUND OF THE INVENTION 1. Field of the Invention

The present invention relates to a design verification method and a design verification device for microprocessors that are capable of performing logical verification of RTL descriptions in a design of microprocessors, and to a pipeline simulator generation device.

2. Description of the Related Art

Conventionally, the procedure shown in a flowchart of FIG. 1 is widely known and used as this type of the verification method. In FIG. 1, dotted lines indicate the processes performed by manual, not by automatic processes performed by any computer.

Based on a pipeline specification described by natural-language such as Japanese-language, English, and so on, a RTL (Register Transfer Level) description for a microprocessor to be verified is made by manual (Step S101).

In addition, a source program for a simulator is made based on the pipeline specification by manual (Step S102), and a pipeline simulator is generated based on the source program of the simulator made at Step S102 and a source program for a simulator that is independent of the pipeline specification (Step S104).

In addition, verification items are made by manual based on the pipeline specification (Step S105), and a plurality of verification programs are then made based on the verification items (Step S106).

Next, a RTL simulation is executed based on the RTL description of the microprocessor and the verification programs by a RTL simulator (Step S107). Further, by using the verification programs, the pipeline simulator performs the pipeline simulation (Step S108). Then, both the result of the RTL simulation (Step S109) and the result of the pipeline simulation (Step S110) are compared in order to judge whether the pipeline operation passes or fails (Step S112).

Such verification procedures have a following drawback. This drawback is caused by the ambiguity of the pipeline specification.

In the conventional verification method shown in FIG. 1, the pipeline specification is described in Japanese-language, English-language, and the like so that an operator can understand easily the content of this pipeline specification. Accordingly, although it must be defined strictly, the quality of the pipeline specification is depended on the ability of the operator who describes the pipeline specification.

Such situation also occurs in a case in which the operator interprets the pipeline specification described in natural language. That is, there is a possibility that a RTL implementer, a pipeline simulator implementer, or a verification program maker misunderstands the pipeline specification.

In the RTL verification, the misunderstanding by the pipeline simulator implementer causes to reduce the efficiency of the verification, because the pipeline simulator is used as a reference model. That is, the verification operation is performed on the assumption that the pipeline simulator absolutely outputs correct results when it is compared with the result of the RTL simulation.

The misunderstanding of the verification program maker introduces the drawback to uncheck one or some logical verifications. If microprocessors are manufactured under some logical verifications that have been unchecked, and when the application software detects the error of the microprocessors manufactured, the logical design must be performed again in the worst case. Further, the conventional verification method cannot respond quickly to the change of a micro-architecture of the microprocessor.

There are various micro-architectures in one instruction set architecture, and the specification of the micro-architecture is often changed in the design stage. Accordingly, in the conventional logical verification method, the operator must change both the pipeline simulator and the verification programs by manual every the change of the specification of the micro-architecture in the design stage.

As described above, because the conventional logical verification method for the RTL description of microprocessors performs the RTL implementation, the pipeline simulator implementation, and the verification programs making based on a same pipeline specification described in a natural-language, different operators occur different interpretations to this pipeline specification, so that interpretation errors occur. Further, because the verification program is made by manual based on the pipeline specification, there is a possibility that the operator avoids some verification that must be verified.

Furthermore, it is difficult for the operator to find and study a problem's source when the disparity between the result of the RTL simulation and the result of the pipeline simulation based on the verification programs occurs.

Moreover, it is also difficult to meet the change of the specification of a micro-architecture and the like in order to achieve the increasing of the performance of a microprocessor.

### SUMMARY OF THE INVENTION

Accordingly, an object of the present invention is, with due consideration to the drawbacks of the conventional technique, to provide a design verification method and a design verification device for microprocessors that are capable of verifying the operation of a pipeline preciously and adequately, and to provide a pipeline simulator generation device.

In accordance with a preferred embodiment of the present invention, the design verification method for microprocessors, comprises the following steps: the step of generating verification programs by a computer based on a pipeline specification of a microprocessor as a target in design described in a description language readable and analyzable by a computer; the step of executing a simulation of a RTL description of the microprocessor based on the generated verification programs and the RTL description; the step of generating a pipeline simulator by the computer based on the pipeline specification; the step of executing a pipeline simulation based on the verification programs and the generated pipeline simulator; and the step of comparing a result of the simulation of the RTL description and a result of the pipeline simulation, and verifying pipeline operation of the microprocessor based on a comparison result. Thereby, even if the specification of a micro-architecture and the like is changed in order to achieve the increasing of the performance of a microprocessor, the design verification method for microprocessors of the present invention can verify the operation of a pipeline of the microprocessor preciously and adequately.

In accordance with another preferred embodiment of the present invention, a design verification device for microprocessors comprises the following sections: the input section for inputting a pipeline specification of a microprocessor as a target in design described in a description language readable and analyzable by a computer; the simulator generation section for generating a pipeline simulator by the computer based on the pipeline specification input through the input section; the program generation section for generating verification programs by the computer based on the pipeline specification input through the input section; the RTL simulation execution section for executing a pipeline simulation of a RTL description based on the verification programs generated by the program generation section and the RTL description of the microprocessor; the pipeline simulation execution section for executing a pipeline simulation based on the verification programs generated by the program generation section and the pipeline simulator generated by the simulator generation section; and the comparison section for comparing a result of the simulation executed by the RTL simulation execution section and a result of the pipeline simulation executed by the pipeline simulation execution section, and verifying an operation of the pipeline of the microprocessor based on a comparison result. Thereby, even if the specification of a micro-architecture and the like is changed in order to achieve the increasing of the performance of a microprocessor, the design verification device for microprocessors of the present invention can verify the operation of a pipeline of the microprocessor preciously and adequately.

### BRIEF DESCRIPTION OF THE DRAWINGS

These and other objects, features, aspects and advantages of the present invention will become more apparent from the following detailed description of the present invention when taken in conjunction with the accompanying drawings, in which:

FIG. 1 is a flow chart showing a procedure of a conventional design verification method for microprocessors;

FIG. 2 is a flow chart showing a procedure of a design verification method for microprocessors according to the first embodiment of the present invention; and

FIG. 3 is a diagram showing a configuration of a design verification device for microprocessors according to the second embodiment of the present invention.

### DESCRIPTION OF THE PREFERRED EMBODIMENTS

Other features of this invention will become apparent through the following description of preferred embodiments that are given for illustration of the invention and are not intended to be limiting thereof.

First embodiment

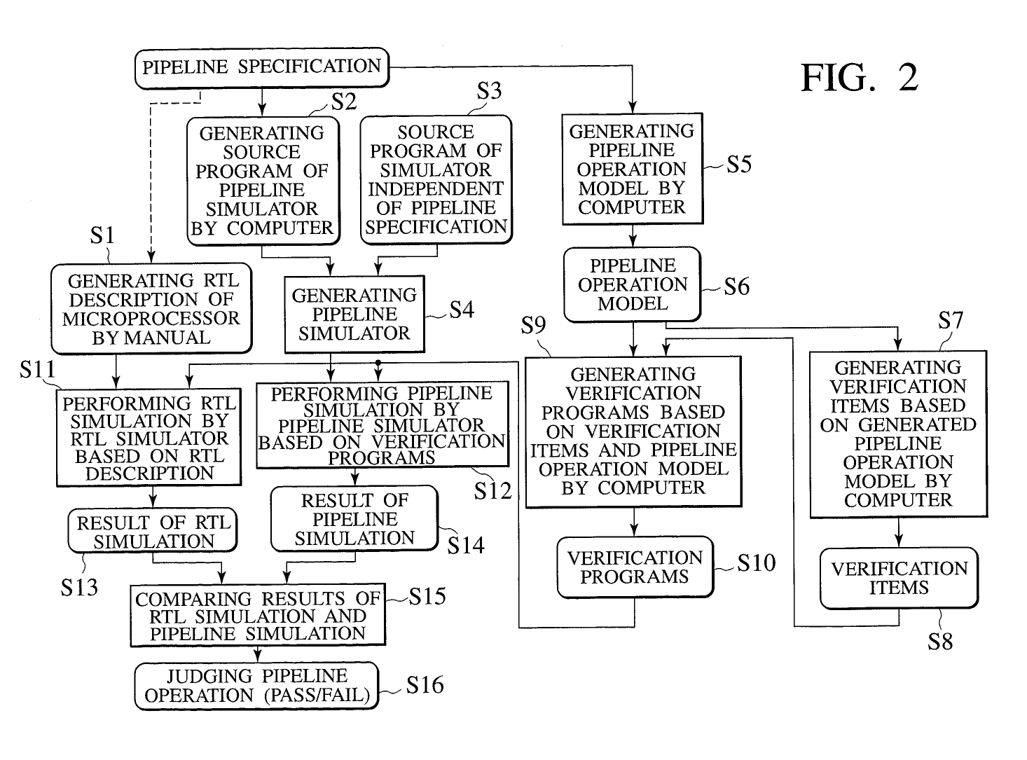

FIG. 2 is a flow chart showing the procedure of the design verification method for microprocessors according to the first embodiment of the present invention.

The design verification method for microprocessors according to the present invention inputs a pipeline specification for a microprocessor and is capable of generating a simulator with a cycle-accurate (hereinafter, referred to as a pipeline simulator) based on the pipeline specification, and also capable of generating a model of a pipeline operation based on the pipeline specification, and further of generating verification programs that are necessary and sufficient conditions for verifying the pipeline operation based on the generated model of the pipeline operation. These functions can perform the simulation for the RTL description of the microprocessor based on the verification programs generated, and can execute the pipeline simulation using the same verification programs. Then, because both the results obtained from the above operations are then compared automatically, it is thereby possible to perform the logical verification for the RTL description of the microprocessor efficiently and completely without any occurrence of unverified state.

Next, a description will be given of the operation of the design verification method of the microprocessor according to the first embodiment of the present invention.

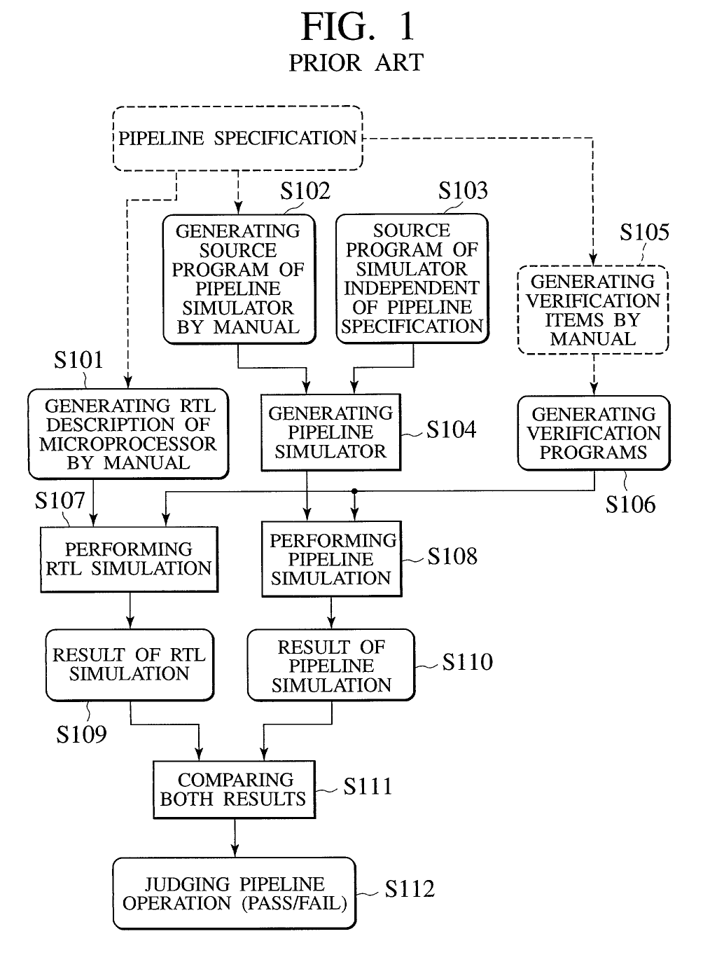

The dotted line in FIG. 2 indicates the process by manual, just like the conventional design verification method for microcomputer shown in FIG. 1.

In FIG. 2, the RTL description for the microprocessor to be verified is made by manual based on a pipeline specification (that will be explained in detail later) written in a computer-readable language, not in a natural-language (Step S1).

In addition, a computer then generates a source program of a simulator based on the above pipeline specification (Step S2).

Then, the computer generates a pipeline simulator (Step S4) based on both the source program of the simulator generated above and a source program (Step S3) that is independent of the pipeline specification.

Further, the computer generates a pipeline operation model based on the pipeline specification (Step S5), and generates verification items (Step S7) based on the pipeline operation model generated (Step S6).

The computer then generates verification programs (Step S9) based on the generated verification items (Step S8) and the pipeline operation model (Step S6). The verification programs can be thereby obtained (Step S10).

For example, the Japanese patent application number JP-A-H11-74118 has disclosed the method to generate the pipeline operation model based on the pipeline specification and to generate the verification models based on the pipeline operation model.

In Step S5, the pipeline operation model is generated. That is, a graph of a pipeline structure expressed by a directed graph to express connection relationships among stages forming the pipeline are generated, the stall condition under a structure hazard is determined, and a finite state machine that recognizes combinations of pipeline stages as states are generated.

The verification items are expressed by the combinations of the pipeline stages. In Step S7, the verification items are generated. That is, the state of each pipeline stage in which the structure hazard occurs and each pipeline stage in which the data hazard occurs are listed.

In Step S9, instruction sequences (as the verification programs) to verify each verification item are automatically generated by using the pipeline operation model and the verification items. The automatic generation for the instruction sequences can be realized by using a BDD (Binary Decision Diagram) The BDD is a kind of graph to express logic function compactly.

The finite state machine is expressed by using the BDD and the instruction sequences are generated by calculating the group of states achievable from the initial state.

Next, the RTL simulator performs the RTL simulation (Step S11) by using the RTL description of the microprocessor and the verification programs (Step S10). In addition, the pipeline simulator performs the pipeline simulation (Step S12) based on the verification programs. Then, the result (Step S13) of the RTL simulation and the result (Step S14) of the pipeline simulation are compared (Step S15) in order to judge (Step S16) whether the pipeline operation is pass or fail.

When the pipeline specification in this verification procedure of the pipeline operation is generated, we define the description language to describe the pipeline specification, and the pipeline specification is then described based on the definition.

Next, a description will be given of an actual description method for the pipeline specification.

The pipeline specification has implied rules, and an instruction is entered into a stall state without any indication. The implied rules are following two control rules (1) and (2):

(1) Executions of multiple instructions are not in a same stage simultaneously; and

(2) The execution of an instruction is completed by in-order.

In the above cases, the same stage means a same actual hardware.

When an instruction is stalled at a stage, it is controlled so that the following stage is stalled. In the case that there are stages that can be executed simultaneously when the function of these stages is same, but the target resources for these stages are different, it must be required to label different names to these stages in the description of the pipeline specification.

A representative example of the description of the pipeline specification for typical instructions will be explained.

In the following description of the pipeline specification, the stages of a pipeline are as follows in time sequence:

F stage (instruction Fetch stage), D stage (instruction Decode stage), E stage (instruction Execution stage), M stage (Memory write/read stage), and W stage (Writeback stage to register).

First, an example of the description of the ALU instruction is shown. The bypass operation is described as follows.

For example, in the ALU pipeline, the calculation result is written into a register at W stage. In this case, when the calculation result can be referred immediately after the E stage or M stage, the description becomes as follows:

ALU.Access(E);

ALU.Forwarding(E+M); and

REG.Writeback(W).

A general description becomes as follows.

Arithmetic unit. Access (Stage(sequence));

Arithmetic unit. Forwarding (Stage(sequence)) ;

Register. Read (stage) ; and

Register. Writeback (stage) .

“Access” is used for judging a resource conflict. The stall is executed by the designation “Access” for a resource conflict. “Read” becomes the base for judging the timing to be prepared.

The simulator executes the instruction in the stage where all operands have been prepared. An instruction not including “Read” is executed immediately following the issue stage (D stage). The designation of both “Forwarding” and “Writeback”is used in the judgment for judging whether data is available or not.

The following is a judgment algorism.

(An example of the judgment algorithm for judging whether data is available or not) if (Forwarding is defined) then

It is available when the prior stage in Forwarding sequence is completed in this clock cycle, or it has been completed else if (Writeback is defined) then

It is available when the Writeback stage is completed in this clock cycle, or it has been completed.

else not available

endif.

Next, a description will be given of the description for the stall operation. For example, when a RAW hazard for general-purpose register REG is detected, the pipeline operation in which D stage is stalled is defined as follows:

Stall Stage (RAW, REG)=D;

A general description is as follows. “RAW”, “WAW”, “CONFLICT (resource conflict)” are specified as factors of the hazard.

Stall Stage (factor of hazard, target resource)=Stage to be stalled;

When there is a description to define the stall, the simulator performs the pipeline operation based on the following algorithm.

(An example of algorithm to control stall by simulator) S: Stage to be stalled, R: target Resource, PI: Prior Instruction using target resource R.

When an instruction is in S stage in a current clock cycle and “RAW” is the factor of a Hazard,

The value to be written into “R” by the prior instruction “PI”is not available at this time, the instruction is stalled.

The factor of the hazard is “WAW” and the write operation to the register “R” in the prior instruction “PI” has not been completed, the stall occurs.

When the factor of the hazard is “CONFLICT” and the prior instruction “PI” is in the access to the register “R”, the stall occurs. In cases other than the above conditions, no stall occurs.

Here, whether or not data to be written to a register by the prior instruction is available can be determined based on the bypass of the prior instruction and the definition of the stage for the register write. This will be explained as follows:

The following is the pipeline specification of the ALU instruction defined based on such manner.

(An example of pipeline specification for ALU instruction)

//ALU pipeline
//When “RAW” hazard is detected, D stage is stalled.
//ALU calculation is performed at E stage, latency is 1.
// Result of ALU arithmetic is forwarded at E or M stage.
// Result is written to the register at W stage.
ALUPipe::ALUPipe( ))
{
name = “ALU_Pipeline”;
Stages = F + D + E + M + W ;
//Relationship between resource and data flow.
REG.Read(D);
ALU.Access(E);
ALU.Forwarding(E + M);
REG.Writeback(W);
//Stage for processing instruction is stalled when hazard

occurs.

Stall Stage(RAW, REG) = D;
}

Next, an example of the description of the pipeline specification will be described.

Load instruction loads data at M stage and then bypasses it.

Thereby, following instructions of data dependence are stalled by one clock cycle.

The description of the pipeline specification to realize the above operation is shown as follows.

(An example of the description of the load pipeline specification)

//Load pipeline
//When RAW hazard is detected, processing of instruction

at D stage is stalled.

//ALU (address calculation) is performed at E stage.
// When data load is completed correctly at M stage, the

data is forwarded at M stage.

```
// Data is written into register at W stage.
LDPipe::LDPipe( )
{
  name = “LoadPipeline”;
  Stages = F + D + E + M + W;
  //Relationship between resource and data flow
  REG.Read(D);
ALU.Access(E);
MMU.Load(M);
REG.Writeback(W);
  // Stage for processing instruction is stalled when hazard
```

occurs.

Stall Stage(RAW, REG) = D;
}

Next, we will consider the following instruction sequence.

1w &1.(&10);

and &2.&1; “and” instruction adheres to the above ALU pipeline definition, “1w” adheres to the above “load” pipeline definition.

This instruction sequence performs the following pipeline operation. The lower-case letter “d” at Time (a) indicates the occurrence of a Stall.

| | | | | | | | | |
|---|---|---|---|---|---|---|---|---|
| 1w &1.(&10) | F | D | E | M | W | | | LOAD pipeline |
| and &2.&1 | | F | d | D | E | M | W | ALU pipeline |
| | | | ↑ | ↑ | | | | |
| | | | (a) | (b) | | | | |

Because Time (a) is D stage, “RAW” hazard is checked. Because the “and” instruction and the prior “1w” instruction have the dependence relationship, it is checked whether or not the result of the “1w” instruction is available. Although the instruction “1w” is in E stage at the timing (a), the result of the LOAD pipeline is not available because the “Forwarding” thereof is started at M stage. Therefore, the “and”instruction is stalled at the timing (a).

Because the “and” instruction is in D stage in the following timing (b), “RAW” hazard is checked.

Similarly, the “and” instruction and the “1w instruction are in the RAW dependence relationship, it is checked whether or not the result of the 37 1w” instruction is available.

Because the “1w” instruction executes M stage, the result of the “1w” instruction is available, no hazard is detected. Accordingly, the “and” instruction is not stalled.

In the above definition of the load pipeline, when the following line (L1) is neglected, the available stage to use the result of the “load” pipeline becomes W stage, and in the same example, D stage is stalled by 2 clock cycles, and it is thereby possible to set the state having no bypass function.

MMU. Forwarding(M); . . . (L1)

Next, an example of pipeline specification of multiplication instruction will be explained. The definition of multiplication pipeline will be explained.

(An example of description of multiplication pipeline specification)

//When RAW hazard of an operand to REG is detected, D stage

is stalled.

//Latency is 2.
//Writing to registers HI/LO is performed at X stage.
//No stall occurs even if there is a resource conflict

to MULDIV.

//When prior instruction is DIV, operation is continued

after DIV is canceled.

//When prior instruction is MUL, operation is continued

after DIV is canceled.

MULTPipe::MULTPipe ()
{
name = “Multiply_Pipeline”;
//Stage name is changed in order to realize completion of

out-of-order
Stages = F + D + C(2) + X;
//Relationship between resource and data flow
REG.Read(D);
MULDIV.Access(C);
HI.Writeback(X)
LO.Writeback(X);
//Stage to be stalled by hazard
Stall Stage(RAW, REG) = D;
//The prior “mul/div” is canceled
F.Makeflush(Mul);
F.Makeflush(Div);
Completion Order = Out of Order; // Completion of out-of-Order
}

During the execution of the multiplication instruction by the multiplication/division unit MULDIV, other instruction can use ALU. However, if we define that the stage to execute MULDIV in a multiplication pipeline is the same E stage of the ALU execution stage, the stall occurs because other instruction cannot access ALU during the MULDIV is accessed. In order to avoid this state, a new C stage is defined for MULDIV.

During the execution of an multiplication instruction, the completion of following instructions having no dependence to this multiplication instruction can precede the completion of the multiplication instruction.

That is, this is the completion of Out-of-order. The following line designates this state in the definition of the above multiplication pipeline.

Completion Order=Out of Order; //Completion of Out-of-Order

If the above line does not exist, the following instructions enter the stall state after the completion of the multiplication instruction even if these following instructions have no dependence to the multiplication instruction.

In addition, based on the control rule not to shift from a plurality of instructions to a same stage, following instructions that are using C stage (multiplication and division) is stalled at previous D stage until the execution of C stage in the multiplication instruction has been completed.

This means that a throughput becomes more than the number of clock cycles of the plural clock cycle stages in default when latency is adjusted in plural clock cycle stages.

In order to set the throughput to not less than the latency, the method to increase the series of the stages is selected. The throughput becomes 1 if the resource conflict is not defined. When the throughput is set to other than 1, for example, the definition “throughput=3” is described in the definition of the pipeline.

When a following multiplication or division instruction is started before the prior multiplication or division instruction has been completed, the prior instruction is cancelled. The control to cancel the prior instruction is as follows:

F.Makeflush(Mul);

F.Makeflush(Div);

The above two definition lines mean that when there is another multiplication or division instruction at F stage in the pipeline, this multiplication or division instruction is canceled. The following shows the general description.

Stage Make flush (Instruction category)

Finally, the pipeline specification for branch instruction will be explained.

In the following pipeline specification, predicting that branch is not taken, the branch instruction judges the condition at E stage, and instructions in both F and D stages are cancelled when the branch is performed.

(Example of description of branch pipeline specification)

```
  //Branch pipeline
  //When RAW hazard is detected, data flow is stalled at D stage.
  //ALU operation (condition judgment) and overwriting for PC
(Program Counter) are performed at E stage.
  BRPipe::BRPipe ( )
  {
```

name = “Branch_Pipeline”;
Stages = F + D + E + M + W;
Predicted Value = Not Taken; //Prediction that branch is

not taken at all times

//Relationship between resource and data flow
REG.Read (D);
ALU.Access(E);
LP.Read(D);
EPC.Read(D)
//Stage to be stalled by hazard
Stall Stage (RAW.REG) = D;
//In a case branch prediction is voided (Branch instruction

is taken at E stage)

//Flush occurs when instructions in F and D stages are shifted

into following clock cycle.

E.setControl(&brHzd);
}

The following description designates a prediction that branch is not taken at all times.

Predicted value Not Taken; //Prediction that no branch is taken at all times.

In the description “Predicted value”, only “Taken” and “Not Taken” can be specified.

The definition “E.setcontrol(&brHzd);” means that branch prediction and operation thereof are performed at E stage. The term “brHzd” is a class object to return the result of the branch prediction.

(An example of the description of the pipeline when a branch prediction occurs.)

void BRPipe::ActionBranchpredict

{
//Prediction of branch is voided.
if (brHzd. BranchPredictResult (Predictedvalue.PC) == false)
//Instructions in F and D stages are flushed.
F.Flush ( );
D.Flush ( );
}

}

The actual operation in E stage can be written by the description described above. When the branch prediction is failed, the instructions in F and D stages are canceled. Thus, it is easily performed to specify the direction of a branch prediction, the stage in which the branch prediction is performed, and the instructions to be canceled at this time.

Although the example of the description using functions of C++ language has been disclosed in detail in the above first embodiment, it is easily possible to prepare a dedicated user-interface to input necessary data items and then to convert obtained data items to functions of C++ language.

Thus, in the first embodiment, the RTL implementation, the generation of the pipeline simulator, and the generation of the verification programs can be performed automatically by the computer based on the same pipeline specification for a microprocessor as a target in design described in a description language readable and analyzable by the computer. It is thereby possible to eliminate any occurrence of errors to be caused by the difference of interpretation by design operators. In addition, because the verification programs are generated automatically by the computer based on the pipeline specification, it is possible to eliminate any occurrence to avoid some verification that must be verified by the operator.

Furthermore, because only the RTL description is implemented by manual based on the pipeline specification, it can be judged that the RTL implementation includes error when both results are not agreed in the comparison between the result of the RTL simulation and the result of the pipeline simulation. This can increase the efficiency to search bugs involved in the design for the microprocessor. Moreover, even if the architecture of the microprocessor is changed in order to increase the performance and the like, the present invention can easily correspond with this change.

Second embodiment.

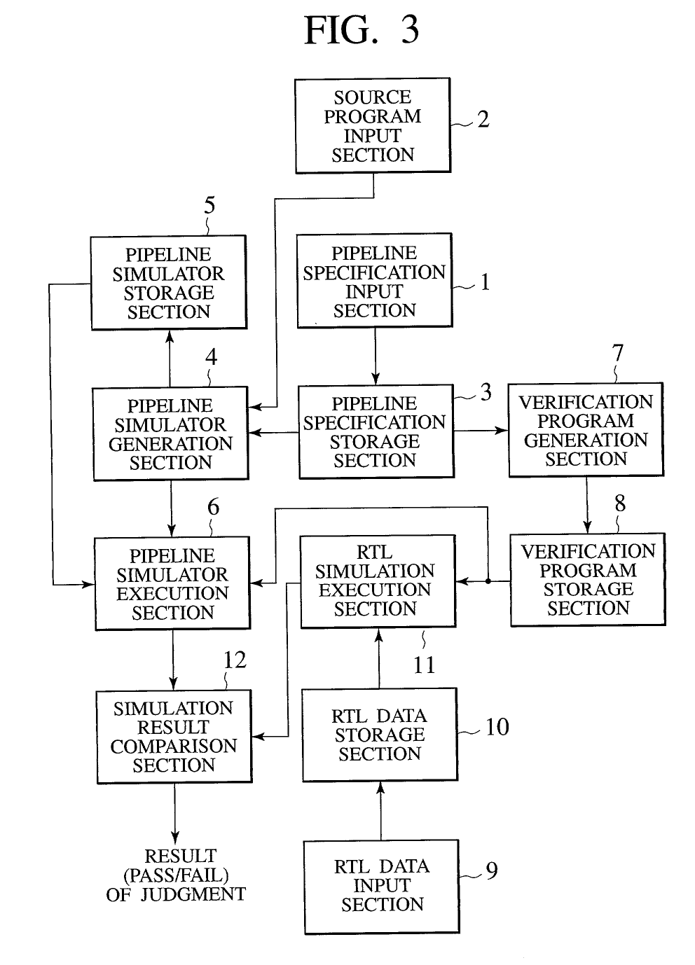

FIG. 3 is a diagram showing a configuration of the design verification device for microprocessors according to the second embodiment of the present invention.

The design verification device for microprocessors according to the second embodiment performs the verification of a microprocessor as a target in design according to the procedure of the design verification method of the first embodiment shown in FIG. 2.

The design verification device for microprocessors according to the second embodiment comprises the following sections 1 to 12:

The pipeline specification input section 1 for inputting a pipeline specification of the microprocessor as a target in design (this pipeline specification has been described in a description language readable and analyzable by a computer.);

The simulator source program input section 2 for inputting a source program of a simulator;

The pipeline specification storage section 3 for storing the pipeline specification input through the pipeline specification input section 1;

The pipeline simulator generation section 4 for generating a pipeline simulator based on the pipeline specification input through the pipeline specification input section 1 and the source program of the simulator input through the simulator source program input section 2;

The pipeline simulator storage section 5 for storing a pipeline simulator generated by the pipeline simulator generation section 4;

The pipeline simulator execution section 6 for executing the pipeline simulator based on the pipeline simulator generated by the pipeline simulator generation section 4 or the pipeline simulator generated by the pipeline simulator storage section 5;

The verification program generation section 7 for generating a pipeline operation model and verification items based on the pipeline specification stored in the pipeline specification storage section 3, and then for generating verification programs;

The verification program storage section 8 for storing the verification programs generated by the verification program generation section 7;

The RTL data input section 9 for inputting RTL data items;

The RTL data storage section 10 for storing the RTL data items input through the RTL data input section 9;

The RTL simulation execution section 11 for executing the RTL simulation based on the RTL data items stored in the RTL data storage section 10; and

The simulation result comparison section 12 for comparing the result of the RTL simulation performed by the RTL simulation execution section 11 and the result of the simulation performed by the pipeline simulator execution section 6, and then for judging whether the operation of the pipeline is pass or fail.

Because the pipeline simulator storage section 5 provides the pipeline simulator (that has been generated by the pipeline simulator generation section 4 and then stored in the pipeline simulator storage section 5 itself) to the pipeline simulator execution section 6 when the pipeline simulator is used repeatedly, the pipeline simulator storage section 5 can be eliminated when the pipeline simulator generation section 4 generates the pipeline simulator each time.

In the above configuration of the design verification device for microprocessors, the simulation for the RTL description is performed based on the verification programs made based on the pipeline specification described in a description language that is readable and analyzable by a computer, and at the same time, the pipeline simulator is also executed by using the same verification programs, so that the logical verification of the RTL description for the microprocessor as the target in design can be performed efficiently and correctly by comparing the execution results of both the RTL simulation and the pipeline simulation. This can achieve to eliminate the case that the operator avoids some verification that must be verified.

Thus, the design verification device for microprocessors according to the second embodiment can have the same effect of the design verification method for microprocessors of the first embodiment that has been prescribed.

As set forth in detail, according to the present invention, it is possible to verify the pipeline operation of the microprocessor as a target in design preciously, efficiently, adequately because the same pipeline specification described in a description language readable and analyzable by a computer can be input commonly for the RTL simulation and the pipeline simulation, and the verification items are then generated automatically by the computer, and both the RTL simulation and the pipeline simulation are thereby performed.

While the above provides a full and complete disclosure of the preferred embodiments of the present invention, various modifications, alternate constructions and equivalents may be employed without departing from the scope of the invention. Therefore the above description and illustration should not be construed as limiting the scope of the invention, which is defined by the appended claims.

What is claimed is:

1. A design verification method for microprocessors, comprising the steps of:
generating verification programs by a computer based on a pipeline specification of a microprocessor as a target in design described in a description language readable and analyzable by a computer;
executing a simulation of a RTL description of the microprocessor based on the generated verification programs and the RTL description;
generating a pipeline simulator by the computer based on the pipeline specification;
executing a pipeline simulation based on the verification programs and the generated pipeline simulator; and
comparing a result of the simulation of the RTL description and a result of the pipeline simulation, and verifying pipeline operation of the microprocessor based on a comparison result.

2. The design verification method for microprocessors as claimed in claim 1, wherein, in the step of generating the pipeline simulator, a source program of the pipeline simulator generated by the computer based on the pipeline specification and a source program of a simulator independent of the pipeline specification are input, and the pipeline simulator is generated based on both the source programs.

3. The design verification method for microprocessors as claimed in claim 1, wherein, in the step of comparing the simulation results, it is verified that the RTL description is correct when both the result of the simulation of the RTL description and the result of the pipeline simulation are agreed.

4. The design verification method for microprocessors as claimed in claim 2, wherein, in the step of comparing the simulation results, it is verified that the RTL description is correct when both the result of the simulation of the RTL description and the result of the pipeline simulation are agreed.

5. The design verification method for microprocessors as claimed in claim 1, wherein, the pipeline specification described in functions of C++ language is used.

6. The design verification method for microprocessors as claimed in claim 2, wherein, the pipeline specification described in functions of C++ language is used.

7. A design verification device for microprocessors, comprising:
an input section for inputting a pipeline specification of a microprocessor as a target in design described in a description language readable and analyzable by a computer;
a simulator generation section for generating a pipeline simulator by the computer based on the pipeline specification input through the input section;
a program generation section for generating verification programs by the computer based on the pipeline specification input through the input section;
a RTL simulation execution section for executing a pipeline simulation of a RTL description based on the verification programs generated by the program generation section and the RTL description of the microprocessor;
a pipeline simulation execution section for executing a pipeline simulation based on the verification programs generated by the program generation section and the pipeline simulator generated by the simulator generation section; and
a comparison section for comparing a result of the simulation executed by the RTL simulation execution section and a result of the pipeline simulation executed by the pipeline simulation execution section, and verifying an operation of the pipeline of the microprocessor based on a comparison result.

8. The design verification device for microprocessors as claimed in claim 7, wherein the input section inputs a source program of the pipeline simulator generated by the computer based on the pipeline specification and a source program of a simulator independent of the pipeline specification, and the simulator generation section generates the pipeline simulator based on both the source programs.

9. The design verification device for microprocessors as claimed in claim 7, wherein the comparison section verifies that the RTL description is correct when both the result of the simulation of the RTL description and the result of the pipeline simulation are agreed.

10. The design verification device for microprocessors as claimed in claim 8, wherein the comparison section verifies that the RTL description is correct when both the result of the simulation of the RTL description and the result of the pipeline simulation are agreed.

11. The design verification device for microprocessors as claimed in claim 7, wherein, the input section inputs the pipeline specification described in functions of C++ language.

12. The design verification device for microprocessors as claimed in claim 8, wherein, the input section inputs the pipeline specification described in functions of C++ language.

13. A pipeline simulator generation device comprising:
an input section for inputting a pipeline specification of a microprocessor as a target in design described in a description language readable and analyzable by a computer; and
a simulator generation section for generating a pipeline simulator by the computer based on the pipeline specification input through the input section.

14. The pipeline simulator generation device as claimed in claim 13, wherein the input section inputs a source program of the pipeline simulator generated by the computer based on the pipeline specification and a source program of a simulator independent of the pipeline specification, and the simulator generation section generates the pipeline simulator based on both the source programs.

15. The pipeline simulator generation device as claimed in claim 13, wherein, the input section inputs the pipeline specification described in functions of C++ language.

16. The pipeline simulator generation device as claimed in claim 14, wherein, the input section inputs the pipeline specification described in functions of C++ language.
